(19) United States
(12) Patent Application Publication
(10) Pub. No.: US 2018/0054471 A1
(43) Pub. Date: Feb. 22, 2018

(54) Hardware Bus Redirection

(71) Applicant: HEWLETT-PACKARD DEVELOPMENT COMPANY, L.P., HOUSTON, TX (US)

(72) Inventors: Daryl T Poe, FORT COLLINS, CO (US); DANIEL BUNGERT, FORT COLLINS, CO (US); RYAN MICHAEL CLEMENS, FORT COLLINS, CO (US); TIMOTHY J FREESE, FORT COLLINS, CO (US)

(21) Appl. No.: 15/557,940

(22) PCT Filed: May 15, 2015
(86) PCT No.: PCT/US15/31193

§ 371 Date: Sep. 13, 2017

(51) Int. Cl. H04L 29/08; H04L 29/06; G06F 13/40

(52) U.S. Cl. CPC H04L 67/08; H04L 67/02; H04L 67/40; G06F 13/40; H04L 69/24; H04L 29/06; H04L 67/141

(57) ABSTRACT

Examples disclosed herein relate to hardware bus redirection. Some examples disclosed herein may include storing, in a data storage, a connection type associated with a resource locator and obtaining an indication that a web browser connection comprising the resource locator has been initiated at the computing device. In response to the indication, some examples disclosed herein may include determining whether the connection type associated with the resource locator corresponds to a remote connection. In response to determining that the connection type corresponds to the remote connection, some examples disclosed herein may include enabling hardware bus redirection for the remote connection.

### BACKGROUND

In a remote desktop environment, a server runs a desktop session locally and provides the outputted graphics information to a remote client for display. In response, the client may output the graphics on an available display and subsequently process input from the user for transmission back to the server. This process continues, with the server transmitting the graphics stream and the client transmitting input events. In this manner, the client device may interact with a remote desktop processed by the server in the same manner as a local desktop processed by the client. Similarly, in a remote application environment, a software application running on a remote server may appear to the user as if it were running locally on the client.

### BRIEF DESCRIPTION OF THE DRAWINGS

The following detailed description references the drawings, wherein:

FIG. 1 is a block diagram depicting an example system for hardware bus redirection.

FIG. 2 is a block diagram depicting an example system for hardware bus redirection.

FIG. 3 is a block diagram depicting an example machine-readable storage medium comprising instructions executable by a processor for hardware bus redirection.

FIG. 4 is a flow diagram depicting an example method for hardware bus redirection.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

Remote desktop environments enable a user to interact with a remote desktop processed by a server (also referred herein as a “server computing device”) in the same manner as a local desktop of a client (also referred herein as a “client computing device). Similarly, in remote application environments, a software application running on a remote server may appear to the user as if it were running locally on the client. In order to improve the user experience, many remote connection solutions include features designed to maintain the allusion that the user is interacting with a local desktop or a local application. One such feature is called hardware bus redirection, which allows a user to interact with a locally-connected hardware bus device (e.g., Universal Serial Bus (USB), Firewire, or other similar device) within the remote connection (e.g., the remote desktop connection, the remote application connection, etc.). In other words, the hardware bus redirection allows access to the locally-connected hardware bus device by the remote desktop or the remote application.

For example, when using USB redirection, a user connects a USB device to the client, which may be a thin client or similar device. The client and server then communicate regarding the availability of a local USB device. When the user requests access to the USB device from within the remote desktop session, the server directs the request to the client, which accesses the local USB device and forwards the requested data to the server. Finally, the server returns the data to the client via the remote desktop session. In this manner, the user may access the USB device within the remote desktop session as if it were directly plugged into the server.

A remote connection (e.g., connection to a remote desktop and/or to a remote application) may be established using at least one of various remote protocols. For example, an administrator or other entity may be able to choose between the Microsoft Remote Desktop Protocol (RDP), VMware View, Citrix Independent Computing Architecture (ICA), or a number of other remote protocols. When the remote connection is established using a particular protocol, the hardware bus redirection may be enabled for that particular protocol.

In some instances, a web browser connection to a web page (e.g., identified by a resource locator such as Uniform Resource Locator (URL)) may be used to launch a remote connection to a remote server. In one example, a web browser connection may be made to a web page on which an option to start a remote connection is available. A user may click on a button on the web page to launch a remote desktop and/or application connection of a particular remote protocol In another example, a web browser connection may be made to a web page that offers the remote desktop and/or application connection directly in a browser window, meaning that the remote desktop and/or application may be displayed directly in the browser window.

However, when the web browser connection is initiated (e.g., a user enters the URL in the browser) at the client, it is challenging to automatically enable the hardware bus redirection for a remote connection because it is unknown, at the time of the browser connection initiation, which remote connection type (e.g., which remote protocol) might be used to establish the remote connection.

Examples disclosed herein provide technical solutions to these technical challenges by assigning a connection type for a resource locator prior to a web browser connection comprising the resource locator is initiated. Some examples disclosed herein may include storing, in a data storage, a connection type associated with a resource locator and obtaining an indication that a web browser connection comprising the resource locator has been initiated at the computing device. In response to the indication, some examples disclosed herein may include determining whether the connection type associated with the resource locator corresponds to a remote connection. In response to determining that the connection type corresponds to the remote connection, some examples disclosed herein may include enabling hardware bus redirection for the remote connection.

The terminology used herein is for the purpose of describing particular embodiments only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “coupled,” as used herein, is defined as connected, whether directly without any intervening, elements or indirectly with at least one intervening elements, unless otherwise indicated. Two elements can be coupled mechanically, electrically, or communicatively linked through a communication channel, pathway, network, or system, The term “and/or” as used herein refers to and encompasses any and all possible combinations of one or more of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

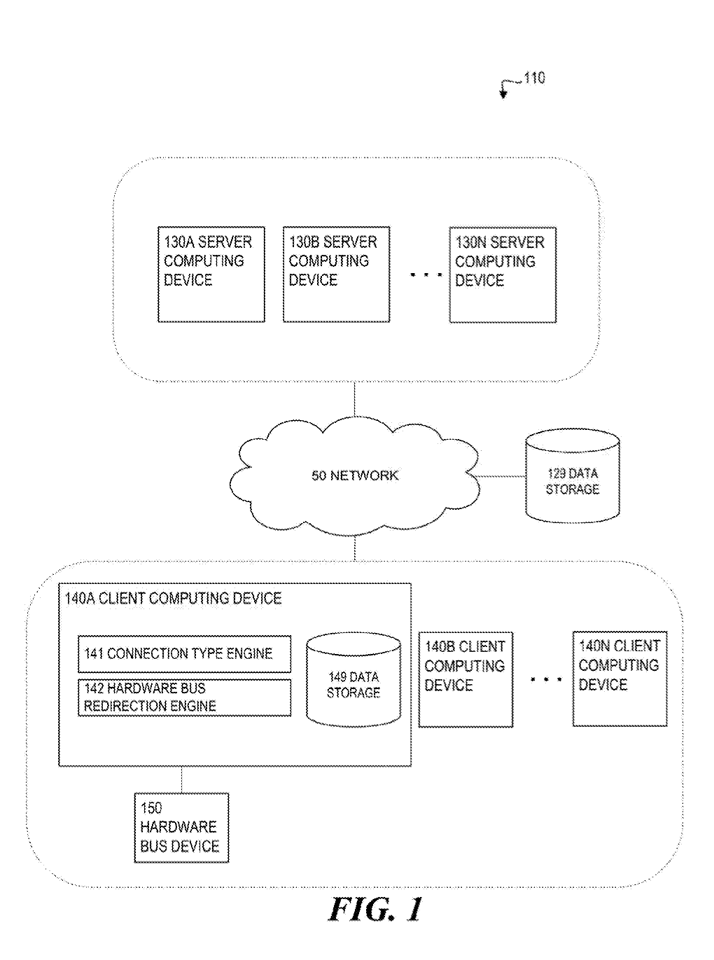

FIG. 1 is a block diagram depicting an example system 100 comprising various components including a client computing device in communication with a server computing device for managing cross-domain information.

The various components may include client computing devices 140 (illustrated as 140A, 140B, . . . , 140N) and server computing devices 130 (illustrated as server computing device 130A, 1308, . . . , 130N). Each client computing device 140A, 1408, . . . , 140N may communicate requests to and/or receive responses from server computing device 130. Server computing device 130 may receive and/or respond to requests from client computing devices 140. Client computing devices 140 may include any type of computing device providing a user interface through which a user can interact with a software application. For example, client computing devices 140 may include a laptop computing device, a desktop computing device, an all-in-one computing device, a thin client, a workstation, a tablet computing device, a mobile phone, an electronic book reader, a network-enabled appliance such as a “Smart” television, and/or other electronic device suitable for execution of the functionality described below. While server computing device 130 is depicted as a single computing device, server computing device 130 may include any number of integrated or distributed computing devices.

The various components (e.g., components 129, 130, and 140) depicted in FIG. 1 may be coupled to at least one other component via a network 50. Network 50 may comprise any infrastructure or combination of infrastructures that enable electronic communication between the components. For example, network 50 may include at least one of the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. According to various implementations, system 100 and the various components described herein may be implemented in hardware and/or programming that configures hardware. Furthermore, in FIG. 1 and other Figures described herein, different numbers of components or entities than depicted may be used.

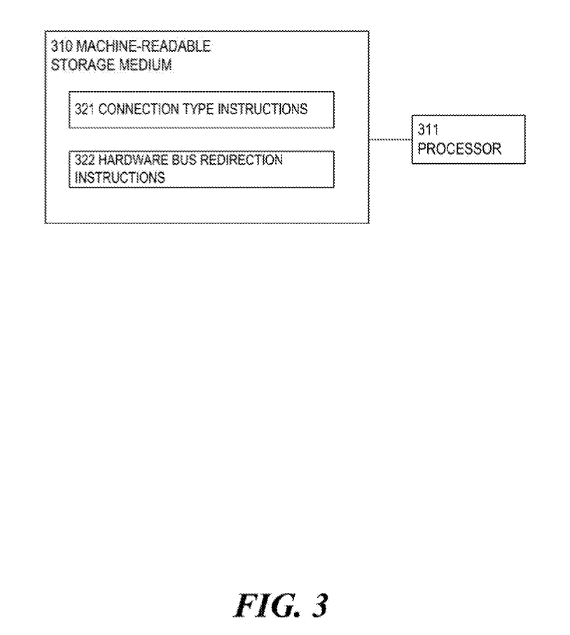

Client computing device 140 may comprise a connection type engine 141, a hardware bus redirection engine 142, and/or other engines. The term “engine”, as used herein, refers to a combination of hardware and programming that performs a designated function. As is illustrated respect to FIG. 3, the hardware of each engine, for example, may include one or both of a processor and a machine-readable storage medium, while the programming is instructions or code stored on the machine-readable storage medium and executable by the processor to perform the designated function.

Connection type engine 141 may identify a resource locator to be assigned and/or associated with a connection type. A “resource locator,” as used herein, may refer to an address for a web page such as a Uniform Resource Locator (URL). A “connection type,” as used herein, may comprise a remote connection type (e.g., a remote protocol such as Microsoft Remote Desktop Protocol (RDP), VMware View, Citrix Independent Computing Architecture (ICA), etc.) or a non-remote connection type. Such remote protocols may be used to establish a remote connection to a remote server computing device (e.g., server computing device 130). Examples of a “remote connection” may include but not be limited to a remote desktop connection and a remote application connection. A remote desktop connection may enable a user to interact with a remote desktop processed by server computing device 130 in the same manner as a local desktop of client computing device 140. A remote application connection may enable a remote application running on server computing device 130 to appear to the user as if it were running locally on client computing device 140.

In some implementations, the resource locator may locate a web page that may be used to launch a remote connection. In one example, the resource locator may locate a web page on which an option to start a remote connection is available. In this example, a user may click on a button on the web page to launch a remote desktop and/or application connection of a particular connection type (e.g., a particular remote protocol). In another example, the web page may offer the remote desktop and/or application connection directly in a browser window, meaning that the remote desktop and/or application may be displayed directly in the browser window.

However, the resource locator has no inherent association with a remote connection type. In other words, it is unknown, at the time when a web browser connection is initiated to the web page using the resource locator (e.g., a user enters the URL in a web browser), which remote connection type (e.g., which remote protocol) might be used to establish the remote connection. Thus, at least one resource locator that needs to be assigned and/or associated with a connection type may be identified, for example, based on a web browser history, information retrieved from an external system, or otherwise manual user input.

Connection type engine 141 may obtain a connection type for a particular resource locator (e.g., identified by connection type engine 141 as discussed above). The connection type may be obtained in various ways. In some implementations, the identified resource locator(s) may be provided to a user (e.g., an individual user, a system administrator, an organization, and/or other entity) via a user interface of client computing device 140. The user may specify a connection type for a particular resource locator of the identified resource locator(s). For example, the user may indicate that the particular resource locator locates a web page that may be used to launch a remote connection of a particular connection type (e.g., RDP remote desktop protocol) and/or may designate the particular resource locator with the particular connection type. In another example, the user may indicate that the particular resource locator locates a web page that is unrelated to a remote connection. In this case, the user may designate the particular resource locator with the non-remote connection type.

In some implementations, connection type engine 141 may present a user interface that allows the user to select a connection type for the particular resource locator. For example. the interface may display a list of remote protocols (and/or an option to select a non-remote connection type) in a drop-down menu or other interface element and thereby allow the user to select the connection type for the particular resource locator.

In some implementations, the connection type may be automatically determined by connection type engine 141 and/or recommended to the user as a recommended connection type for the particular resource locator. In doing so, connection type engine 141 may analyze the particular resource locator to determine the connection type. For example, the address string (e.g., URL string) of the particular resource locator may be analyzed to determine whether the address string includes any features and/or keywords that are related to a remote protocol. An URL may include a keyword term “rdweb” in its address string, which may indicate that the appropriate connection type for this URL would be the RDP remote desktop protocol. Alternatively, if the address string of the URL does not indicate any features and/or keywords that are related to a remote protocol, connection type engine 141 may generate a recommendation that the appropriate connection type for this URL would be the non-remote connection type. Connection type engine 141 may generate a recommendation that recommends the automatically determined connection type for the resource locator and/or provide the recommendation to the user (e.g., via the user interface). The user may either accept or reject the recommendation. If accepted, connection type engine 141 may obtain an indication that the recommendation is accepted by the user.

Connection type engine 41 may store, in a data storage (e.g., data storage 129, 149, and/or other databases), the connection type (e.g., obtained by connection engine 141 as discussed above) associated with the particular resource locator. The data storage may store and/or maintain associations between a plurality of resource locators and corresponding connection types (e.g., as obtained by connection type engine 141 as discussed above).

Hardware bus redirection engine 142 may obtain an indication that a web browser connection comprising the particular resource locator has been initiated at client computing device 140. For example, the user of client computing device 140 may enter a particular URL in a web browser. In response to the indication, hardware bus redirection engine 142 may identify and/or retrieve, from the data storage, the connection type that is associated with the particular resource locator. Hardware bus redirection engine 142 may determine whether this connection type associated with the resource locator corresponds to a remote connection. In other words, hardware bus redirection engine 142 may determine whether the web browser connection (e.g., comprising the particular resource locator) corresponds to a remote connection based on the connection type associated with the particular resource locator. Note that the web browser connection may be said to “correspond” to a remote connection when the web browser connection points to a web page on which an option to start a remote connection (e.g., a remote connection of the particular connection type) is available and/or when the web page offers the remote connection directly in a browser window, meaning that the remote desktop and/or application may be displayed directly in the browser window.

For example, if the connection type indicates the ADP remote desktop protocol, it may be determined that the connection type corresponds to a remote connection. Alternatively, if the connection type indicates a non-remote connection or otherwise fails to indicate a remote protocol, it may be determined that the connection type does not correspond to a remote connection.

In response to determining that the connection type corresponds to the remote connection (and/or the web browser connection corresponds to the remote connection), hardware bus redirection engine 142 may enable hardware bus redirection for the remote connection. The hardware bus redirection allows server computing device 130 to communicate with a hardware bus device (e.g., hardware bus device 150) that is locally connected to client computing device 140. Hardware bus redirection engine 142 may promptly enable the hardware bus redirection for the remote connection of the connection type at the time of the browser connection initiation. In enabling the hardware bus redirection for the remote connection, hardware bus redirection engine 142 may mount hardware bus devices, add kernel modules, start daemon processes, modify the system, and/or perform a number of similar operations depending on the connection type.

In some implementations, hardware bus redirection engine 142 may determine whether the hardware bus redirection is supported by the connection type (e.g., a particular remote protocol). For example, hardware bus redirection engine 142 may query a function provided by the particular remote protocol that indicates whether the hardware bus redirection can be enabled for that protocol. In response to determining that the hardware bus redirection is supported by the particular remote protocol, hardware bus redirection engine 142 may enable the hardware bus redirection for the remote connection. Alternatively, if determined that the hardware bus redirection is not supported by the particular remote protocol, hardware bus redirection engine 142 may not enable the hardware bus redirection for the remote connection. Instead, hardware bus redirection engine 142 may allow a local operation system of client computing device 140 to access a hardware bus device (e.g., hardware bus device 150) that is locally connected to client computing device 140. For example, hardware bus redirection engine 142 may transfer control of the hardware bus device to the local operating system by relying on traditional hardware bus redirection drivers running within the operation system. As a result, a user of client computing device 140 may then access the hardware bus device directly via an operating system of client computing device 140, rather than via a redirection procedure.

In performing their respective functions, engines 141-142 may access data storage 129, data storage 149, and/or other suitable database(s). Data storage 129 and/or other databases may comprise random access memory (RAM), read-only memory (ROM), electrically-erasable programmable read-only memory (EEPROM), cache memory, floppy disks, hard disks, optical disks, tapes, solid state drives, flash drives, portable compact disks, and/or other storage media for storing computer-executable instructions and/or data. Various components in system 110 may access data storage 129 via network 50 or other networks.

Data storages 129 and/or other databases may include a database to organize and store data. The database may reside in a single or multiple physical device(s) and in a single or multiple physical location(s). The database may store a plurality of types of data and/or files and associated data or file description, administrative information, or any other data.

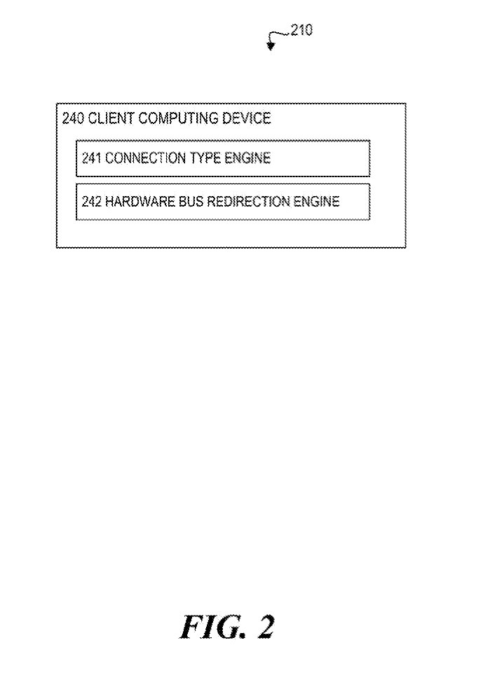

FIG. 2 is a block diagram depicting an example system 210 for hardware bus redirection. System 210 may comprise a client computing device 240 comprising a connection type engine 241, a hardware bus redirection engine 242, and/or other engines. Engines 241-242 represent engines 141-142 respectively.

FIG. 3 is a block diagram depicting an example machine-readable storage medium 310 comprising instructions executable by a processor for hardware bus redirection.

In the foregoing discussion, engines 141-142 were described as combinations of hardware and programming. Engines 141-142 may be implemented in a number of fashions. Referring to FIG. 3, the programming may be processor executable instructions 321-322 stored on a machine-readable storage medium 310 and the hardware may include a processor 311 for executing those instructions. Thus, machine-readable storage medium 310 can be said to store program instructions or code that when executed by processor implements engine 141-142 of FIG. 1.

In FIG. 3, the executable program instructions in machine-readable storage medium 310 are depicted as connection type instructions 321 and hardware bus redirection instructions 322. Instructions 321-322 represent program instructions that, when executed, cause processor 311 to implement engines 141-142, respectively.

Machine-readable storage medium 310 may be any electronic, magnetic, optical, or other physical storage device that contains or stores executable instructions. In some implementations, machine-readable storage medium 310 may be a non-transitory storage medium, where the term “non-transitory” does not encompass transitory propagating signals. Machine-readable storage medium 310 may be implemented in a single device or distributed across devices. Likewise, processor 311 may represent any number of processors capable of executing instructions stored by machine-readable storage medium 310. Processor 311 may be integrated in a single device or distributed across devices. Further, machine-readable storage medium 310 may be fully or partially integrated in the same device as processor 311, may be separate but accessible to that device and processor 311.

In one example, the program instructions may be part of an installation package that when installed can be executed by processor 311 to implement engines 141-142. In this case, machine-readable storage medium 310 may be a portable medium such as a floppy disk, CD, DVD, or flash drive or a memory maintained by a server from which the installation package can be downloaded and installed. In another example, the program instructions may be part of an application or applications already installed. Here, machine-readable storage medium 310 may include a hard disk, optical disk, tapes, solid state drives, RAM, ROM, EEPROM, or the like.

Processor 311 may be at least one central processing unit (CPU), microprocessor, and/or other hardware device suitable for retrieval and execution of instructions stored in machine-readable storage medium 310. Processor 311 may fetch, decode, and execute program instructions 321-322, and/or other instructions. As an alternative or in addition to retrieving and executing instructions, processor 311 may include at least one electronic circuit comprising a number of electronic components for performing the functionality of at least one of instructions 321-322, and/or other instructions.

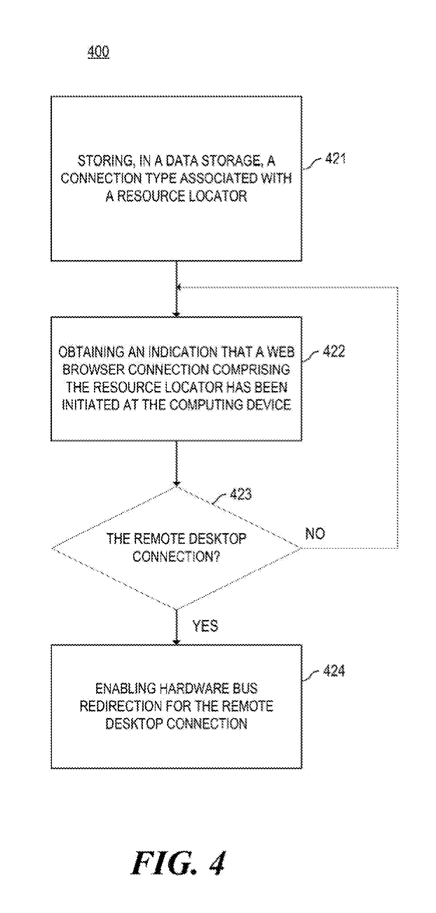

FIG. 4 is a flow diagram depicting an example method 400 for hardware bus redirection, The various processing blocks and/or data flows depicted in FIG. 4 are described in greater detail herein. The described processing blocks may be accomplished using some or all of the system components described in detail above and, in some implementations, various processing blocks may be performed in different sequences and various processing blocks may be omitted. Additional processing blocks may be performed along with some or all of the processing blocks shown in the depicted flow diagrams, Some processing blocks may be performed simultaneously. Accordingly, method 400 as illustrated (and described in greater detail below) is meant to be an example and, as such, should not be viewed as limiting. Method 400 may be implemented in the form of executable instructions stored on a machine-readable storage medium, such as storage medium 310, and/or in the form of electronic circuitry.

In block 421, method 400 may include storing, in a data storage, a connection type associated with a resource locator. Referring back to FIG. 1, connection type engine 141 may be responsible for implementing block 421.

In block 422, method 400 may include obtaining an indication that a web browser connection comprising the resource locator has been initiated at the computing device. Referring back to FIG. 1, hardware bus redirection engine 142 may be responsible for implementing block 421.

In block 423, method 400 may include determining whether the connection type associated with the resource locator corresponds to a remote connection in response to the indication (e.g., obtained in block 422). Referring back to FIG. 1, hardware bus redirection engine 142 may be responsible for implementing block 423. If determined that the connection type corresponds to a remote connection, method 400 may proceed to block 424. Otherwise, method 400 may return to block 422.

In block 424, method 400 may include enabling hardware bus redirection for the remote connection. Referring back to FIG. 1, hardware bus redirection engine 142 may be responsible for implementing block 424.

The foregoing disclosure describes a number of example implementations for hardware bus redirection. The disclosed examples may include systems, devices, computer-readable storage media, and methods for hardware bus redirection. For purposes of explanation, certain examples are described with reference to the components illustrated in FIGS. 1-3. The functionality of the illustrated components may overlap, however, and may be present in a fewer or greater number of elements and components.

Further, all or part of the functionality of illustrated elements may co-exist or be distributed among several geographically dispersed locations. Moreover, the disclosed examples may be implemented in various environments and are not limited to the illustrated examples. Further, the sequence of operations described in connection with FIG. 4 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A method for execution by a computing device for hardware bus redirection, the method comprising:
storing, in a data storage, a connection type associated with a resource locator;
obtaining an indication that a web browser connection comprising the resource locator has been initiated at the computing device;
in response to the indication, determining whether the connection type associated with the resource locator corresponds to a remote connection; and
in response to determining that the connection type corresponds to the remote connection, enabling hardware bus redirection for the remote connection.

2. The method of claim 1, wherein the connection type comprises a remote protocol, and wherein the remote connection is established via the remote protocol that is used by the computing device for communication with a server computing device.

3. The method of claim 2, wherein the hardware bus redirection allows the server computing device to communicate with a hardware bus device that is locally connected to the computing device.

4. The method of claim 1, wherein storing, in the data storage, the connection type associated with the resource locator comprises:
analyzing the resource locator to determine the connection type; and
generating a recommendation that recommends the connection type for the resource locator.

5. The method of claim 2, wherein enabling the hardware bus redirection for the remote connection comprises:
determining whether the hardware bus redirection is supported by the remote protocol; and
in response to determining that the hardware bus redirection is supported by the remote protocol, enabling, the hardware bus redirection for the remote connection.

6. The method of claim 5, further comprising:
in response to determining that the hardware bus redirection is not supported by the remote protocol, allowing a local operating system of the computing device to access a hardware bus device that is locally connected to the computing device.

7. The method of claim 1, wherein the remote connection is a remote desktop connection or a remote application connection.

8. A machine-readable storage medium comprising instructions executable by a processor of a computing device for hardware bus redirection, the machine-readable storage medium comprising:
instructions to analyze a plurality of resource locators to determine a connection type for each of the plurality of resource locators, the plurality of resource locators comprising a particular resource locator;
instructions to obtain an indication that a web browser connection comprising the particular resource locator has been initiated at the computing device;
in response to the indication, instructions to determine whether the web browser connection corresponds to a remote connection based on the connection type associated with the particular resource locator; and
in response to determining that the web browser connection corresponds to the remote connection, instructions to enable hardware bus redirection for the remote connection.

9. The machine-readable storage medium of claim 8, wherein the instructions to analyze the plurality of resource locators to determine the connection type for each of the plurality of resource locators further comprise:
instructions to generate a recommendation as to the connection type for the particular resource locator based on the analysis;
instructions to provide the recommendation to a user of the computing device; and
instructions to obtain an indication that the recommendation is accepted by the user.

10. The machine-readable storage medium of claim 8, wherein the connection type comprises a particular remote desktop protocol, and wherein the remote connection, that is established via the particular remote desktop protocol, allows a user of the computing device to interact with a remote desktop processed by a server computing device in the same manner as a local desktop processed by the computing device.

11. The machine-readable storage medium of claim 10, further comprises:
instructions to determine whether the particular remote desktop protocol supports the hardware bus redirection prior to enabling the hardware bus redirection for the remote connection.

12. A system for hardware bus redirection comprising:
a computing device comprising:
a connection type engine to:
provide a first recommendation that recommends a first connection type for a first resource locator to a user of the computing device, and
obtain an indication that the first recommendation is accepted by the user; and
a hardware bus redirection engine to:
in response to a first web browser connection comprising the first resource locator has been initiated at the computing device, enable hardware bus redirection for a remote connection of the first connection type, wherein the hardware bus redirection, when enabled, allows a server computing device to access a hardware bus device that locally connected to the computing device.

13. The system of claim 12, wherein the first connection type comprises a first remote protocol, the hardware bus redirection engine to:
determine whether the hardware bus redirection is supported by the first remote protocol; and
in response to determining that the hardware bus redirection is supported by the first remote protocol, enable the hardware bus redirection for the remote connection to be established using the first remote protocol.

14. The system of claim 12, wherein the first connection type comprises a second remote protocol, the hardware bus redirection engine to:
determine whether the hardware bus redirection is supported by the second remote protocol; and
in response to determining that he hardware bus redirection is supported by the second remote protocol, enable the hardware bus redirection for the remote connection to be established using the second remote protocol.

15. The system of claim 12,
the connection type engine to:
provide a second recommendation that recommends a second connection type for a second resource locator to the user of the computing device, the second connection type indicating that the second resource locator is not the remote connection, and
obtain an indication that the second recommendation is accepted by the user; and
the hardware bus redirection engine to:
in response to a second web browser connection comprising the second resource locator has been initiated at the computing device, allow a local operating system of the computing device to access the hardware bus device that is locally connected to the computing device.
